(19) United States
(12) Patent Application Publication
(10) Pub. No.: US 2020/0071462 A1
(43) Pub. Date: Mar. 5, 2020

(54) METHOD OF POLYMERIZING AN IONIC CROSSLINKER

(71) Applicant: General Electric Company, Schenectady, NY (US)

(72) Inventors: Yonghong ZHAO, Singapore (SG); Russell James MACDONALD, Westborough, MA (US); John H. BARBER, Guelph (CA)

(21) Appl. No.: 16/613,360

(22) PCT Filed: May 15, 2017
(86) PCT No.: PCT/US2017/032628

§ 371 Date: Nov. 13, 2019

(51) Int. Cl. C08G 65/00; C08J 5/22; B01J 41/14; B01J 41/07; B01J 47/12

(52) U.S. Cl. CPC C08G 65/002; C08J 5/2231; C08J 2333/26; B01J 41/07; B01J 47/12; B01J 41/14

(57) ABSTRACT

The present disclosure provides a polymerizing method where (i) an ionic crosslinker that includes a quaternary ammonium group and (ii) a non-ionic crosslinker, is polymerized in a reaction solution whose solvent is substantially a mixture of propylene glyocol (PG) and an aprotic amide-based solvent. The polymerization makes an anion-exchange polymer composition. The PG and the aprotic amide-based solvent are present in a weight ratio of from about 25:75 to about 70:30, and the reactants and solvents are present in amounts to generate the anion-exchange polymer composition with a theoretical water content from about 35% to about 60% (wt/wt).

### FIELD

The present disclosure relates to a method of polymerizing an ionic crosslinker that includes a quaternary ammonium group.

### BACKGROUND

The following paragraph is not an admission that anything discussed in it is prior art or part of the knowledge of persons skilled in the art.

Ion exchange materials are commonly employed to treat and remove ionizable components from fluids for a variety of applications. Flow-through beds or flow-through devices for fluid treatment may employ exchange material or components in the form of grains, fabrics or membranes. The ion exchange functionality operates to transport one type of ion across the material in an electric field, while substantially or effectively blocking most ions of the opposite polarity. Anion exchange polymers and materials carry cationic groups, which repel cations and are selective to anions. Cation exchange polymers and materials carry anionic groups, which repel anions and are selective to cations.

### Introduction

The following introduction is intended to introduce the reader to this specification but not to define any invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

Most chemical reactions require the reagents to be solubilized in a solvent. Polymerization methods where one reactant is charged, for example where a monomer includes a cationic group, require the identification of a solvent that is capable of dissolving the polar charged monomer. Since such a reactant also includes non-polar functional groups, for example a polymerization group and/or a group that links the cationic group to the polymerization group, the solvent needs to also be able to dissolve substantially non-polar compounds. Polar aprotic solvents, such as dimethyl sulfoxide (DMSO), dimethylformamide (DMF), and N-methyl-2-pyrrolidone (NMP), are known to dissolve both polar and non-polar compounds. Certain mixtures of water and water-miscible glycols (such as polyethylene glycols) may also dissolve both polar and non-polar compounds. However, solubility of the polymerization reactants does not guarantee that the physical characteristics of the resulting polymer will be acceptable, especially when assessing the requirements for ion-exchange membranes. There remains a need for a solvent or solvent mixture whose use in a polymerization method results in a polymer with acceptable physical characteristics.

The present disclosure provides a polymerization method where (i) an ionic crosslinker that includes a quaternary ammonium group and (ii) a non-ionic crosslinker are polymerized in a solvent mixture that is substantially propylene glyocol (PG) and an aprotic, amide-based solvent. In the polymerization method, the PG and the aprotic, amide-based solvent are present in a weight ratio of from about 25:75 to about 70:30; and the reagents and solvents are present in amounts to generate an anion-exchange polymer with a theoretical water content from about 35% to about 60%.

In some examples, the polymerization reaction may also include a monomer. The solvent mixture may be used to dissolve the optional monomer without other solvents.

The ionic crosslinker may be formed in situ from the reaction between a tertiary amine, such as a tertiary amine linked to a polymerizable functional group, and an alkylating agent, such as a di-epoxide or a di-halide. In some such exemplary ionic crosslinkers, the crosslinker includes two quaternary ammonium groups. The two quaternary ammonium groups being formed from the reaction between two teriary amines and two alkylating groups on the alkylating agent. Once the ionic crosslinker is formed, the crosslinker may be used in a polymerization reaction without being purified or otherwise separated from the solvent mixture.

In some methods of the present disclosure, the solvent mixture is believed to reduce or prevent polymerization of the tertiary amine monomer at reaction temperatures that are suitable for the amine-epoxide reaction that forms the ionic crosslinker having a quaternary ammonium group. For example, the ionic crosslinker may be formed in situ by the reaction between N-[3-(dimethylamino)propyl] methacrylamide (DMAPMA) and 1,4-cyclohexanedimethanol diglycidyl ether (CHDMDGE), dibromobutane (DBB), or dibromohexane (DBH). When these reactants are dissolved in NMP, polymerization of the DMAPMA begins to occur when the reaction is heated to around 50° C. When dissolved in PG, polymerization of the DMAPMA begins to occur when the reaction is heated to around 70° C. However, when dissolve in a mixture of 70:30 (wt/wt) PG:NMP, the reaction mixture may be heated to 78° C. without substantial polymerization of the DMAPMA. Heating to 78° C. is a suitable temperature for the reaction between the tertiary amine of DMAPMA and the epoxides of CHDMDGE or the dibromides of DBB or DBH.

Similarly, the ionic crosslinker may be formed in situ by the reaction between 2-(dimethylamino)ethyl methacrylate (DMAEMA), and 1,4-cyclohexanedimethanol diglycidyl ether (CHDMDGE), dibromobutane (DBB), or dibromohexane (DBH). When dissolved in a mixture of 70:30 (wt/wt) PG:NMP, the reaction mixture may be heated to 50° C. without substantial polymerization of the DMAEMA. Heating to 50° C. is a suitable temperature for the reaction between the tertiary amine of DMAEMA and the epoxides of CHDMDGE or the dibromides of DBB or DBH.

### BRIEF DESCRIPTION OF THE DRAWINGS

Embodiments of the present disclosure will now be described, by way of example only, with reference to the attached Figures.

FIG. 1 shows a table summarizing the amounts of solvents and reactants used in methods according to the present disclosure.

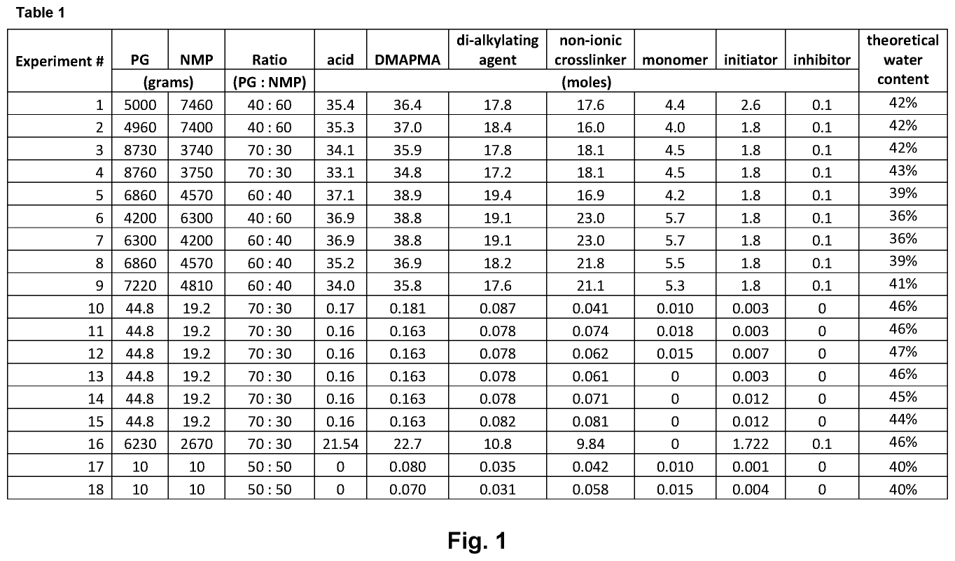

FIG. 2 shows a table summarizing the amounts of solvents and reactants used in methods according to the present disclosure.

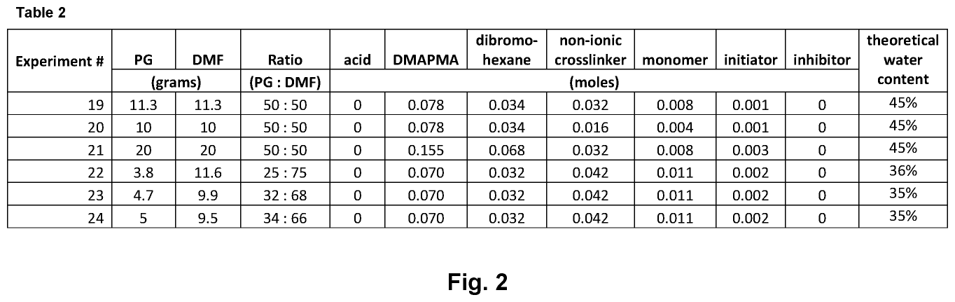

FIG. 3 shows a table summarizing the amounts of solvents and reactants used in comparative methods.

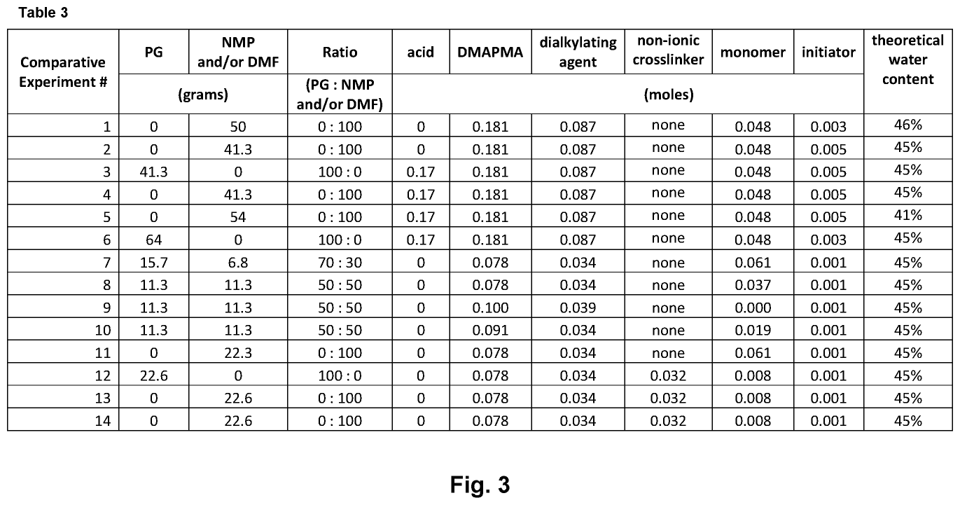

### DETAILED DESCRIPTION

The singular forms “a”, “an”, and “the” include plural references unless the context clearly dictates otherwise.

The endpoints of all ranges reciting the same characteristic are independently combinable and inclusive of the recited endpoint.

The modifier “about” used in connection with a quantity is inclusive of the stated value and has the meaning dictated by the context (e.g., includes the tolerance ranges associated with measurement of the particular quantity, or includes the values that would be rounded to the particular quantity based on the recited significant figures).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

Generally, the present disclosure provides a polymerization method where (i) an ionic crosslinker that includes a quaternary ammonium group and (ii) a non-ionic crosslinker are polymerized in a solvent mixture that is substantially a mixture of propylene glyocol (PG) and an aprotic, amide-based solvent, such as N-methyl-2-pyrrolidone (NMP), dimethyl formamide (DMF), or dimethylacetamide (DMAc). The aprotic, amide-based solvent may be referred to as “the amide-based solvent”, but is not intended to include protic amide-based solvents, such as 2-pyrrolidione, or N-methylformamide. The PG and the amide-based solvent are present in a weight ratio of from about 25:75 to about 70:30. In particular examples, the weight ratio is from about 50:50 to about 70:30. In more particular examples, the weight ratio is from about 60:40 to about 70:30. The reagents and solvents are present in amounts to generate an anion-exchange polymer with a theoretical water content from about 35% to about 60%.

In the context of the present disclosure, a solvent mixture that is “substantially” PG and the amide-based solvent refers to a solvent mixture that is at least 95% by volume PG or the amide-based solvent. The remaining portion of the solvent mixture may be a solvent that is soluble with the PG and amide-based solvent mixture.

The theoretical water content of a polymer is calculated by dividing the total weight of the solvents by the total weight of the reagents plus the solvents, ignoring the weights of any polymerization initiator or inhibitor. For example, a polymerization that included a total of 27 grams of crosslinkers and optional monomers, dissolved in a total of 20 grams of solvents, would result in polymer having a theoretical water content of 20/(27 +20)=42.5%. In particular examples of the present disclosure, the theoretical water content is from about 35% to about 50%. A water content of about 40% to about 50% is particularly useful for electrodialysis reversal (EDR) based water treatment methods and systems. A water content of about 30% to about 45% is particularly useful for electrodialysis (ED) based water treatment methods and systems.

Each of the ionic crosslinker and the non-ionic crosslinker include at least two radical-based polymerizable groups. The expression “radical-based polymerizable group” (and alternatively “polymerizable group”) should be understood to refer to functional groups that polymerize under free radical polymerization conditions. When the polymerization includes an additional monomer, the optional monomer also includes a radical-based polymerizable functional group. Each polymerizable functional group in each of the reactants used in the polymerization reaction may be independently selected, so long as they are all polymerizable under the same polymerizing conditions. In one example of polymerizable functional groups being independently selected: the polymerizable groups on the ionic crosslinker may be vinyl groups, while the polymerizable groups on the non-ionic linker may be an acrylate. In this example, if an optional monomer was also included in the reaction mixture, the monomer could include an acrylamide.

In some examples according to the present disclosure, each polymerizable group in a reactant used in the polymerization reaction is a vinyl-based functional group. Vinyl-based functional groups include vinyl groups, acrylic groups, and acrylamide groups. Non-limiting examples of compounds that have a polymerizable vinyl group include: vinyl benzene; divinyl benzene; 1,3-divinylimidazolidin-2-one; and N-vinyl caprolactam. Non-limiting examples of compounds that have an acrylic group include: dimethylaminoethylmethacrylate (DMAEMA), and ethylene glycol dimethacrylate (EGDMA). Non-limiting examples of compounds that have an acrylamide group include: methacrylamide; N-hydroxymethylacrylamide; N[3-(dimethylamino)propyl]methacrylamide; and N,N′-methylenebis(acrylamide). In the context of the present disclosure, all of the listed exemplary compounds would be considered to have “vinyl-based functional groups”.

The ionic crosslinker includes at least one a quaternary ammonium group and at least two polymerizable groups. The ionic crosslinker may be the reaction product formed from the reaction between a tertiary amine compound and an alkylating compound. The polymerizable groups may be a part of the tertiary amine compound, the alkylating agent, or both. In some examples, the ionic crosslinker is the reaction product formed from the reaction between two tertiary amine compounds, each of which include a polymerizable group, and a poly-alkylating compound. The poly-alkylating compound may be, for example, a poly-epoxide or a poly-halide, such as a poly-bromide.

Ionic crosslinkers having at least one quaternary ammonium group are disclosed in WO2013052227, and are incorporated herein by reference. Such ionic crosslinkers may be used in methods according to the present disclosure.

In particular examples, the ionic crosslinker is formed from the reaction between DMAPMA or DMAEMA, and CHDMDGE. The resulting crosslinkers have the following structures (not showing the counter-ions), respectively:

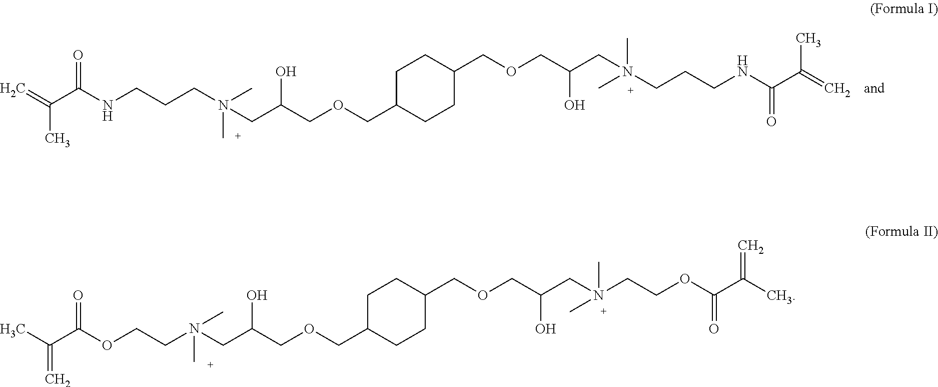

In other particular examples, the ionic crosslinker is formed from the reaction between DMAPMA or DMAEMA, and DBB or DBH. The resulting crosslinkers have the following structures (not showing the counter-ions).

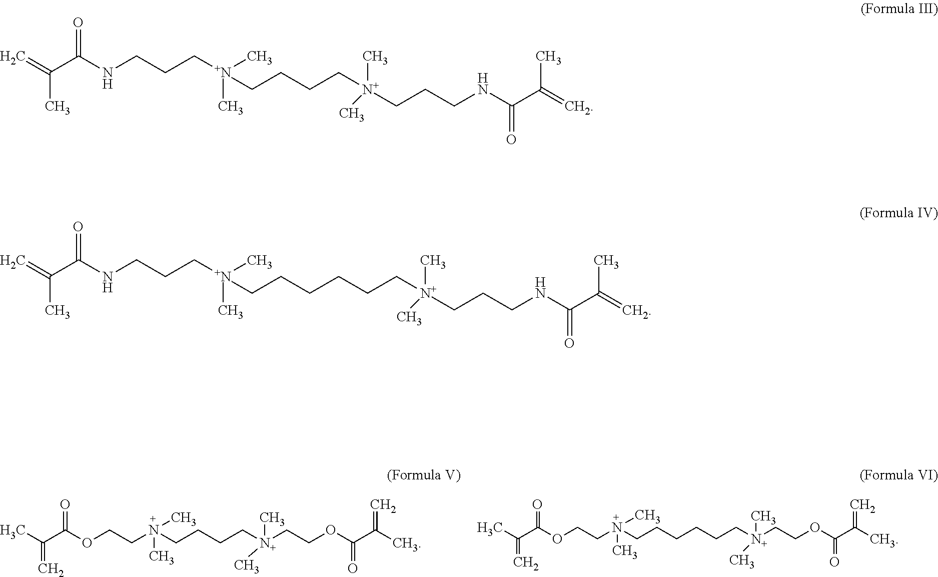

The solvent mixture that is substantially from about 25:75 to about 70:30 (wt/wt) of PG:amide-based solvent may be particularly effective in methods according to the present disclosure where DMAPMA or DMAEMA are used to form the ionic crosslinker in situ. The solvent mixture, particularly when the weight ratio is from about 50:50 to about 70:30, and more particularly when the weight ratio is from about 60:40 to about 70:30, is believed to reduce the likelihood of polymerization of DMAPMA or DMAEMA at an elevated temperature that is still suitable for their reaction with CHDMDGE, DBB, or DBH. For example, methods that use the solvent mixture according to the present disclosure may form the ionic crosslinker using DMAPMA at a temperature of up to about 78° C. Methods that use the solvent mixture according to the present disclosure may form the ionic crosslinker using DMAEMA at a temperature of up to about 50° C. The rate of reaction between the tertiary amine and the alkylating agent increases at higher temperatures, so it may be desirable to form the ionic crosslinker using DMAPMA at a temperature of about 78° C., or using DMAEMA at a temperature of about 52° C. At these temperatures in the solvent mixture, there is substantially no polymerization of DMAPMA, DMAEMA, or CHDMDGE. Polymerization of the DMAPMA, DMAEMA, or CHDMDGE before formation of the ionic crosslinker may prevent the formation of an anion-exchange membrane (for example because the reactants react before they can polymerize on the cloth), or may result in an anion-exchange membrane with undesirable physical characteristics (such as: an undesirably soft membrane, or a membrane with an undesirable amount of spalling).

As discussed above, the non-ionic crosslinker in the polymerization reaction includes at least two radical-based polymerizable groups that are polymerizable under the same polymerizing conditions as the polymerizable groups of the ionic crosslinker. Examples of non-ionic crosslinkers that may be used in the presently disclosed method include: divinyl benzene (DVB), ethylene glycol dimethacrylate (EGDMA); 1,3-divinylimidazolidin-2-one (DVI); and N,N′-methylenebis(acrylamide) (MBA).

Methods according to the present disclosure may be used to generate anion-exchange membranes, such as by additionally casting the polymerization reaction solution on a cloth backing before polymerizing the reactants. The cloth backing may be a woven or non-woven cloth. The backing may be made, for example, of polyacrylonitrile (PAN), polypropylene (PP), polyethylene (PE), polyethylene terephthalate (PET), or polyvinylchloride (PVC). The thickness of the cloth backing may be selected so that the resulting anion-exchange membrane is from about 0.1 mm to about 0.8 mm. Curing the reactants may include exposure of the reaction mixture to an elevated temperature, such as about 50° C. to about 120° C., and/or to a UV light. In particular methods, the curing includes increasing the temperature from room temperature to about 120° C. using multiple heating tables.

In one specific example of a method according to the present disclosure, the method includes dissolving DMAPMA or DMAEMA and an acid in a solvent mixture without allowing the temperature to exceed the temperature that promotes polymerization of the DMAPMA or DMAEMA. In the exemplary method, the solvent mixture is substantially propylene glyocol (PG) plus NMP, DMF, or a combination of both, in a weight ratio of from about 25:75 to about 70:30. An amount of the solvent mixture is chosen in view of the planned amounts of polymerization reagents so that the theoretical water content of the eventual polymer is from about 35% to about 60%.

The acid may be hydrochloric acid, methane sulfonic acid, sulfuric acid, or phosphoric acid. A radical inhibitor, such as monomethyl ether hydroquinone (MeHQ), may optionally be included in the solvent mixture.

The exemplary method may include lowering the temperature of the reaction solution to about room temperature. Lowering the temperature of the solution may involve removing the heat source and allowing the reaction solution to equilibrate to room temperature; or actively cooling the reaction solution. In the exemplary method, a vinyl-based crosslinker, and a polymerization initiator, are dissolved in the reaction solution to provide a polymerization reaction solution. The exemplary method may optionally include dissolving a vinyl-based monomer. The reactants are cured, allowing the reactants to polymerize to form an anion-exchange polymer composition.

In the exemplary method: the vinyl-based crosslinker may independently be: divinyl benzene (DVB), ethylene glycol dimethacrylate (EGDMA); 1,3-divinylimidazolidin-2-one (DVI); or N,N′-methylenebis(acrylamide) (MBA), the vinyl-based monomer may be: N-vinyl caprolactam (V-Cap); vinylbenzyl chrolide (VBC); methacrylamide (MAA); or ethylvinylbenzene, and the polymerization initiator may be: trimethylbenzoyl diphenylphosphine oxide (TPO); dimethyl 2,2′-azobis(2-methylpropionate) (V-601); 2,2′-azobis[2-(2-imidazolin-2-yl)propane]dihydrochloride (V-044); or 2,2′-azobis(2-methylpropionamidine)dihydrochloride (V-50).

The exemplary method may optionally include casting the polymerization reaction solution on a cloth backing before polymerizing the reactants, in order to generate an anion-exchange membrane. The cloth backing may be: a polyacrylonitrile (PAN), polypropylene (PP), polyethylene (PE), or polyethylene terephthalate (PET) cloth. The exemplary method may optionally include conditioning the anion-exchange polymer composition.

In one specific example of the exemplary method, DMAPMA is dissolved in the solvent mixture, MSA is added, and the reaction mixture is heated to 70° C. to allow the DMAPMA to react with the MSA so as to protonate the tertiary amine in the DMPAMA. CHDMDGE is added and the reaction mixture is heated to 78° C. to allow the protonated DMAPMA to react with the CHDMDGE. The reaction mixture is cooled to room temperature. Divinylbenzene and a polymerization initiator are added, the reaction mixture is cast on a cloth backing, and the reaction mixture is cured.

In another specific example of the exemplary method, DMAPMA is dissolved in the solvent mixture. DBH or DBB is added, and the reaction mixture is heated to 78° C. to allow the DMAPMA to react with the DBH or DBB. The reaction mixture is cooled to room temperature. Divinylbenzene and a polymerization initiator are added, the reaction mixture is cast on a cloth backing, and the reaction mixture is cured.

In another specific example of the exemplary method, DMAEMA is dissolved in the solvent mixture, MSA is added, and the reaction mixture is heated to 50° C. to allow the DMAEMA to react with the MSA so as to protonate the tertiary amine in the DMAEMA. CHDMDGE is added and the reaction mixture is kept at 50° C. to allow the protonated DMAEMA to react with the CHDMDGE. The reaction mixture is cooled to room temperature. Divinylbenzene and a polymerization initiator are added, the reaction mixture is cast on a cloth backing, and the reaction mixture is cured.

In another specific example of the exemplary method, DMAEMA is dissolved in the solvent mixture. DBH or DBB is added, and the reaction mixture is heated to 50° C. to allow the DMAEMA to react with the DBH or DBB. The reaction mixture is cooled to room temperature. Divinylbenzene and a polymerization initiator are added, the reaction mixture is cast on a cloth backing, and the reaction mixture is cured.

### EXAMPLES AND COMPARATIVE EXAMPLES

Various exemplary methods according to the present disclosure were compared to other methods. The polymerization reaction mixtures in these experiments and comparative experiments were applied to a woven or non-woven fabric made of polyacrylonitrile, polypropylene, polyethylene, polyvinyl chloride, or polyethylene terephthalate to generate a membrane.

A summary of the reactants and solvents used to form the polymerization reaction mixtures are shown in the figures. The comparative experiments resulted in anion-exchange membranes with one or more undesirable physical characteristic.

Tables 1 and 2 show experiments where the weight ratio of PG to NMP or DMF is from about 25:75 to about 70:30, and where the theoretical water content is from about 35% to about 60%. Table 3 shows comparative experiments where (a) the weight ratio of PG to NMP and/or DMF falls outside of the range, and/or (b) the reaction lacks a non-ionic crosslinker.

All the experiments in Table 1 used NMP as the amide-based solvent. Experiments 1-16 used CHDMDGE as the dialkylating agent. Experiments 17 and 18 used dibromohexane (DBH) as the dialkylating agent. The DMAPMA and the CHDMDGE or DBH formed the ionic crosslinker in situ. Experiments 1-12, 17 and 18 of Table 1 used DVB80 as the non-ionic crosslinker. Experiments 13-16 of Table 1 used EGDMA as the non-ionic crosslinker.

All the experiments in Table 2 used DMF as the amide-based solvent, used DBH as the dialkylating agent, and DVB80 as the non-ionic crosslinker. The DMAPMA and the DBH formed the ionic crosslinker in situ.

Comparative Experiments 1-6 in Table 3 used CHDMDGE as the dialkylating agent, V-Cap as the monomer, and did not include a non-ionic crosslinker. Comparative Experiments 7-11 used DBH as the dialkylating agent; methacrylamide (MAA), V-Cap, or VBC as the monomer; and did not include a non-ionic crosslinker. Comparative Experiments 12-14 used DBH as the dialkylating agent, DVB80 as a non-ionic crosslinker, but did not use a mixture of PG to NMP or DMF that was from about 25:75 to about 70:30. Wth regard to the aprotic, amide-based solvents in the comparative experiments, Comparative Experiment 1 used a 1:1 mixture of NMP and DMF; Comparative Experiments 2, 9 and 13 used NMP; and Comparative Experiments 4, 5, 7, 8, 10, 11 and 14 used DMF.

All the experiments in Tables 1-3 used TPO or V-601 as initiators. MeHQ was used as a radical inhibitor. DVB80 is 80% divinyl benzene and 20% ethylvinylbenzene. The moles of non-ionic crosslinker and monomer in the tables reflect this mixture.

Comparative Experiments (results not shown) using 1-propanol as a solvent, or as a co-solvent with PG or DMF, resulted in anion-exchange membranes with one or more undesirable physical characteristic.

Experiments 1-12, Table 1

MeHQ was dissolved in a solvent mixture of PG/NMP. DMAPMA was dissolved in the solvent mixture, and MSA was added sufficiently slowly that the temperature did not exceed 60° C. After the MSA was added, the temperature of the reaction mixture was increased to 70° C. for 30 minutes. CHDMDGE was added to the solvent mixture and the temperature was increased to 78° C. The reaction mixture was stirred for 1 hour, then cooled to room temperature. DVB80 then TPO were added to the reaction mixture. The resulting polymerization mixture was cast on PAN and/or PP cloths, and sandwiched with mylars and glass plates, and then cured in oven at 90° C. for 1 hour. The cured membrane was conditioned in 1 N NaCl solution for 24 hours.

Experiments 13-16, Table 1

MeHQ was dissolved in a solvent mixture of PG/NMP. DMAPMA was dissolved in the solvent mixture, and MSA was added sufficiently slowly that the temperature did not exceed 60° C. After the MSA was added, the temperature of the reaction mixture was increased to 70° C. for 30 minutes. CHDMDGE was added to the solvent mixture and the temperature was increased to 78° C. The reaction mixture was stirred for 1 hour, then cooled to room temperature. EGDMA then TPO were added to the reaction mixture. The resulting polymerization mixture was cast on PAN and PP cloths, and sandwiched with mylars and glass plates, and then cured in oven at 90° C. for 1 hour. The cured membrane was conditioned in 1 N NaCl solution for 24 hours.

Experiments 17-18, Table 1

MeHQ was dissolved in a solvent mixture of PG/NMP. DMAPMA was dissolved in the solvent mixture, and DBH was added to the solvent mixture and the temperature was increased to 78° C. The reaction mixture was stirred for 1 hour, then cooled to room temperature. DVB80 then TPO were added to the reaction mixture. The resulting polymerization mixture was cast on PP cloth, and sandwiched with mylars and glass plates, and then cured in oven at 90° C. for 1 hour. The cured membrane was conditioned in 1 N NaCl solution for 24 hours.

Experiments 19-24, Table 2

MeHQ was dissolved in a solvent mixture of PG/DMF. DMAPMA was dissolved in the solvent mixture, and DBH was added to the solvent mixture and the temperature was increased to 78° C. The reaction mixture was stirred for 1 hour, then cooled to room temperature. DVB80 then TPO were added to the reaction mixture. The resulting polymerization mixture was cast on PAN, PP, or polyester cloth and sandwiched with mylars and glass plates, and then cured in oven at 90° C. for 1 hour. The cured membrane was conditioned in 1 N NaCl solution for 24 hours.

### Comparative Example 1, Table 3

DMAPMA was dissolved in a solvent mixture of DMF/NMP, and CHDMDGE was added to the solvent mixture and the temperature was increased to 76° C. The reaction mixture was stirred for 1 hour, then cooled to room temperature. V-Cap then TPO were added to the reaction mixture. The resulting polymerization mixture was cast on PAN. The resultant membrane was very soft.

### Comparative Example 2, Table 3

DMAPMA was dissolved in NMP, and 33% HCl was added to the mixture at such a rate that the mix temperature was not over 40° C., and then, CHDMDGE was added to the mixture. Afterwards, the mix was heated up, and it was found that polymerization took place at ˜45° C., before adding V-Cap and V601.

### Comparative Example 3, Table 3

DMAPMA was dissolved in PG, and 33% HCl was added to the mixture at such a rate that the mix temperature was not over 40° C., and then CHDMDGE was added to the mixture. Afterwards, the mix was heated up and it was found that polymerization took place at −70° C., before adding V-Cap and V601.

### Comparative Example 4, Table 3

DMAPMA was dissolved in DMF, and 33% HCl was added to the mixture at such a rate that the mix temperature was not over 40° C., and then CHDMDGE was added to the mixture. The reaction mixture was stirred for 1 hour, then cooled to room temperature. V-Cap then V-601 were added to the reaction mixture. The resulting polymerization mixture was cast on PAN and PP cloths, and sandwiched with mylars and glass plates, and then cured in an oven at 90° C. for 1 hour. The cured membrane was conditioned in 1 N NaCl solution for 24 hours. The resultant membranes were soft.

### Comparative Experiment 5, Table 3

DMAPMA was dissolved in DMF, and MSA was added sufficiently slowly that the temperature did not exceed 60° C. After the MSA was added, the temperature of the reaction mixture was increased to 70° C. for 30 minutes. CHDMDGE was added to the solvent mixture and the temperature was increased to 78° C. The reaction mixture was stirred for 1 hour, then cooled to room temperature. V-Cap then V-601 were added to the reaction mixture. The resulting polymerization mixture was cast on PAN and PP cloths, and sandwiched with mylars and glass plates, and then cured in an oven at 90° C. for 1 hour. It was found that there was no polymerization.

### Comparative Experiment 6, Table 3

DMAPMA was dissolved in PG, and MSA was added sufficiently slowly that the temperature did not exceed 60° C. After the MSA was added, the temperature of the reaction mixture was increased to 70° C. for 30 minutes. CHDMDGE was added to the solvent mixture and the temperature was increased to 78° C. The reaction mixture was stirred for 1 hour, then cooled to room temperature. V-Cap then TPO were added to the reaction mixture. The resulting polymerization mixture was cast on PAN and PP cloths, and sandwiched with mylars and glass plates, and then cured in oven at 90° C. for 1 hour. The cured membrane was conditioned in 1 N NaCl solution for 24 hours. The resultant membranes were soft.

### Comparative Experiment 7, Table 3

DMAPMA was dissolved in a solvent mixture of PG and DMF, and DBH was added to the solvent mixture and the temperature was increased to 78° C. The reaction mixture was stirred for 1 hour, then cooled to room temperature. Methacrylamide (MAA) and then TPO were added to the reaction mixture. The resulting polymerization mixture was cast on PP and polyester cloths, sandwiched with mylars and glass plates, and then cured in oven at 90° C. for 1 hour. The cured membranes were conditioned in 1 N NaCl solution for 24 hours. The resultant membranes spalled seriously.

### Comparative Experiment 8, Table 3

DMAPMA was dissolved in a solvent mixture of PG and DMF, and DBH was added to the solvent mixture and the temperature was increased to 78° C. The reaction mixture was stirred for 1 hour, then cooled to room temperature. V-Cap then TPO were added to the reaction mixture. The resulting polymerization mixture was cast on PP and polyester cloths, sandwiched with mylars and glass plates, and then cured in oven at 90° C. for 1 hour. The cured membranes were conditioned in 1 N NaCl solution for 24 hours. The resultant membranes were soft.

### Comparative Experiment 9, Table 3

DMAPMA was dissolved in a solvent mixture of PG and NMP, and DBH was added to the solvent mixture and the temperature was increased to 76° C. The reaction mixture was stirred for 1 hour, then cooled to room temperature. Monomers precipitated out at room temperature.

### Comparative Experiment 10, Table 3

DMAPMA was dissolved in a solvent mixture of PG and DMF, and DBH and VBC were added to the solvent mixture and the temperature was increased to 76° C. The reaction mixture was stirred for 1 hour, then cooled to room temperature. TPO were added to the reaction mixture. The resulting polymerization mixture was cast on PP cloth, sandwiched with mylars and glass plates, and then cured in oven at 90° C. for 1 hour. The cured membrane was conditioned in 1 N NaCl solution for 24 hours. The resultant membrane was soft.

### Comparative Experiment 11, Table 3

DMAPMA was dissolved in DMF, and DBH was added to the solvent mixture and the temperature was increased to 78° C. The reaction mixture was stirred for 1 hour, then cooled to room temperature. MAA then TPO were added to the reaction mixture. The resulting polymerization mixture was cast on PAN, PP and polyester cloths, sandwiched with mylars and glass plates, and then cured in oven at 90° C. for 1 hour. The cured membranes were conditioned in 1 N NaCl solution for 24 hours. The resultant membranes spalled seriously and were soft.

### Comparative Experiment 12, Table 3

DMAPMA was dissolved in PG, and DBH and DVB80 was added to the solvent mixture and the temperature was increased to 78° C. The reaction mixture was stirred for 1 hour, and it was found that the mix turned to cloudy.

### Comparative Experiment 13, Table 3

DMAPMA was dissolved in NMP, and DBH and DVB80 were added to the solvent mixture. When the temperature was increased to −40° C., the reaction mixture solidified.

### Comparative Experiment 14, Table 3

DMAPMA was dissolved in DMF, and DBH and DVB80 were added to the solvent mixture and the temperature was increased to 78° C. The reaction mixture was stirred for 1 hour, then cooled to room temperature. TPO was added to the reaction mixture. The resulting polymerization mixture was cast on PP cloth, sandwiched with mylars and glass plates, and then cured in oven at 90° C. for 1 hour. The cured membrane was conditioned in 1 N NaCl solution for 24 hours. The resultant membrane had cracks.

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

What is claimed is:

1. A method comprising:
polymerizing (i) an ionic crosslinker that includes a quaternary ammonium group and (ii) a non-ionic crosslinker, in a reaction solution whose solvent is substantially a mixture of propylene glyocol (PG) and an aprotic amide-based solvent, to make an anion-exchange polymer composition,
wherein the PG and the aprotic amide-based solvent are present in a weight ratio of from about 25:75 to about 70:30, and
wherein the reactants and solvents are present in amounts to generate the anion-exchange polymer composition with a theoretical water content from about 35% to about 60% (wt/wt), such as from about 30% to about 50% (wt/wt).

2. The method according to claim 1, wherein the solvent mixture is at least about 95% (v/v) of the PG and the aprotic amide-based solvent.

3. The method according to claim 1, wherein the aprotic amide-based solvent is N-methyl-2-pyrrolidone (NMP), dimethyl formamide (DMF), or a mixture of NMP and DMF.

4. The method according to claim 1, wherein the non-ionic crosslinker is:
a. divinyl benzene;
b. ethylene glycol dimethacrylate (EGDMA);
c. 1,3-divinylimidazolidin-2-one (DVI);
d. N,N′-methylenebis(acrylamide) (MBA);
e. N-methacrylamidomethy acrylamide; or
f. the reaction product between an acrylamide compound with another acrylamide compound that includes hydroxyl groups, such as the reaction product between methacrylamide (MAA) and N-hydroxymethylacrylamide (NHMA).

5. The method according to claim 1, wherein the polymerizing step additionally includes polymerizing a monomer.

6. The method according to claim 5, wherein the monomer is:
a. N-vinyl caprolactam (V-Cap);
b. vinylbenzyl chrolide (VBC);
c. methacrylamide (MAA); or
d. ethylvinylbenzene.

7. The method according to claim 1, wherein each polymerizable functional group of each polymerizable reactant is independently selected from the group consisting of vinyl-based functional groups, for example acrylic or acrylamide functional groups.

8. The method according to claim 1, further comprising, prior to the polymerizing:
forming the ionic crosslinker by reacting a tertiary amine compound with an alkylating compound.

9. The method according to claim 8, wherein the tertiary amine compound is an ethylenic tertiary amine, such as dimethylaminopropylmethacrylamide (DMAPMA), dimethylaminoethylmethacrylate (DMAEMA), dimethylaminopropylacrylamide (DMAPAA), or diethylaminopropylmethacrylamide (DEAPMA).

10. The method according to claim 8, wherein the alkylating compound is a poly-epoxide or a poly-halide.

11. The method according to claim 10, wherein the poly-halide is a poly-bromoalkane, such as 1,4-dibromobutane or 1,6-dibromohexane.

12. The method according to claim 10, wherein the poly-epoxide is a di-epoxide or tri-epoxide, for example a diglycidyl ether or a triglycidyl ether.

13. The method according to claim 12, wherein the di-epoxide is: 1,3-butadiene diepoxide; dicyclopentadiene dioxide; or methyl cis,cis-11,12;14,15-diepoxyeicosanoate.

14. The method according to claim 12, wherein the diglycidyl ether is: diethylene glycol diglycidyl ether; diglycidyl 1,2-cyclohexanedicarboxylate: N,N-diglycidyl-4-glycidyloxyaniline; bisphenol A diglycidyl ether; brominated bisphenol A diglycidyl ether; bisphenol F diglycidyl ether; 1,4-butanediol diglycidyl ether; 1,4-butanediyl diglycidyl ether; 1,4-cyclohexanedimethanol diglycidyl ether; glycerol diglycidyl ether; resorcinol diglycidyl ether; bis[4-(glycidyloxy)phenyl]methane; bisphenol A propoxylate diglycidyl ether; dimer acid diglycidyl ester; ethylene glycol diglycidyl ether; brominated neopentyl glycol diglycidyl ether; diglycidyl ether-terminated poly(dimethylsiloxane); poly(ethylene glycol) diglycidyl ether; poly(propyleneglycol) diglycidyl ether; or 1,3-butanediol diglycidyl ether.

15. The method according to claim 12, wherein the triglycidyl ether is: tris(2,3-epoxypropyl)isocyanurate; trimethylolpropane triglycidyl ether; tris(4-hydroxyphenyl)methane triglycidyl ether 2,6-tolylene diisocyanate; tris(4-hydroxyphenyl)methane triglycidyl ether; glycerol propoxylate triglycidyl ether; trimethylolethane triglycidyl ether; or 1,2,3-propanetriol triglycidyl ether.

16. The method according to claim 8, wherein forming the ionic crosslinker is performed at a reaction temperature that promotes alkylation, but does not promote polymerization.

17. The method according to claim 1, wherein polymerizing the ionic crosslinker comprises polymerizing the reactants on a woven or non-woven cloth backing, such as a polyacrylonitrile (PAN) cloth, a polypropylene (PP) cloth, a polyethylene (PE) cloth, a polyethylene terephthalate (PET) cloth, or a polyvinyl chloride (PVC) cloth.

18. A method comprising:
dissolving dimethylaminopropylmethacrylamide (DMAPMA) in a solvent mixture that is substantially (i) propylene glyocol (PG) and (ii) N-methyl-2-pyrrolidone (NMP), dimethylformamide (DMF), or both, where the two solvents are present in a weight ratio of from about 25:75 to about 70:30;
dissolving an acid and 1,4-cyclohexanedimethanol diglycidyl ether (CHDMDGE), or dissolving dibromohexane (DBH) or dibromobutane (DBB) in the solvent mixture;
increasing the temperature of the reaction solution to about 78° C. and allowing (a) the DMAPMA, and (b) the CHDMDGE, DBH, or DBB, to react to form a quaternary-ammonium-containing crosslinker;
lowering the temperature of the reaction solution to about room temperature;
dissolving a non-ionic crosslinker and a polymerization initiator in the reaction solution to provide a polymerization reaction solution; and
polymerizing the reactants in the reaction solution to form an anion-exchange polymer composition;
wherein the method optionally includes casting the polymerization reaction solution on a cloth backing before polymerizing the reactants, in order to generate an anion-exchange membrane; and
wherein the method optionally includes conditioning the anion-exchange polymer composition.

19. The method according to claim 18 wherein:
a. the acid is hydrochloric acid, methane sulfonic acid, sulfuric acid, or phosphoric acid;
b. the cloth backing is: a polyacrylonitrile (PAN), polypropylene (PP), polyethylene (PE), polyethylene terephthalate (PET) cloth, or polyvinyl chloride (PVC);
c. the non-ionic crosslinker is: divinyl benzene; ethylene glycol dimethacrylate (EGDMA); 1,3-divinylimidazolidin-2-one (DVI); or N,N′-methylenebis(acrylamide) (MBA);
d. the polymerization initiator is: trimethylbenzoyl diphenylphosphine oxide (TPO); dimethyl 2,2′-azobis(2-methylpropionate) (V-601); 2,2′-azobis[2-(2-imidazolin-2-yl)propane]dihydrochloride (V-044); or 2,2′-azobis(2-methylpropionamidine)dihydrochloride (V-50); or
e. any combination thereof.
